(19) United States
(12) Patent Application Publication
(10) Pub. No.: US 2016/0317253 A1
(43) Pub. Date: Nov. 3, 2016

(54) Enossal single tooth implant

(71) Applicant: EPIPHANOSTICS GMBH, Holzkirchen (DE)

(72) Inventor: Walter Duerr, Remchingen (DE)

(73) Assignee: Epiphanostics GmbH, Holzkirchen (DE)

(21) Appl. No.: 15/103,885

(22) PCT Filed: Dec. 16, 2014
(86) PCT No.: PCT/DE2014/100449

§ 371 Date: Jun. 13, 2016

(30) Foreign Application Priority Data
Dec. 17, 2013 (DE) 10 2013 114 170.6

(51) Int. Cl. A61C 8/00

(52) U.S. Cl. CPC A61C 8/0068; A61C 8/0054; A61C 8/0089; A61C 8/0069; A61C 8/006

(57) ABSTRACT

An enossal single tooth implant for a fixed dental prosthesis includes an essentially cylindrical base body which can be inserted into a boring in a jaw bone, an abutment which can be inserted in the annular recess of the base body and has a boring for receiving a retaining screw and with a securing head for the dental prosthesis and a retaining screw which can be inserted into the blind hole of the base body and traverses the abutment.

The invention relates to an enossal single tooth implant for a fixed dental prosthesis with the features of claim 1.

In a single tooth implant as is known from DE 40 28 855 C2 and is also the subject matter of DE 195 09 762.9-32, anti-rotation protection is provided in that the base body form-fitting elements are provided on the base of the annular recess of the base body and the spacer sleeve form-fitting elements which are complementary thereto, on the front end for the centring collar of the spacer sleeve. In manufacturing terms such form-fitting elements are relatively difficult to produce, wherein in some cases it is not particularly beneficial that the full depth of the annular seat/centring collar is not available for centring, fixing and securing the spacer sleeve relative to the base body.

In another dental implant as well, as is proposed in DE 37 35 378, similar problems also occur due to the fact that there too the form-fitting elements of the base body are at a distance from its coronal front edge within a blind hole of the base body.

From DE 41 27 839 A1 an implant base body is known, the central annular recess of which has a form-fitting element which directly adjoins the coronal front edge of the base body, wherein the form-fitting element is groove-like and the retaining component to be inserted into the base body body is of a form complementary thereto. A separate implant post is not envisaged.

From DE 195 34 979 C1 an implant base body is known in which the form-fitting elements of the base body are arranged in direct connection to its coronal front edge with corresponding arrangement and configuration of the complementary abutment form-fitting elements. As the entire depth of the annular recess of the base body is available for the centring and guiding of the abutment, there should be considerably improved stability of the connection between the spacer sleeves and base body in connection with greater design flexibility in terms of the type of separation and design of the form-fitting elements.

From WO 2013083125 an enossal single tooth implant for a fixed dental prosthesis is known which has a base body with an annular recess with a form-fitting section, an abutment insertable into the recess of the base body, wherein complementary form-fitting elements are provided on the base body and abutment and designed in the form of a male component-female component connection.

Although the enossal single tooth implant known from aforementioned WO 2013083125 already provides very good anti-rotation protection, the present invention further develops the implant known from the prior art in that with the same guiding and centring of the abutment in the base body and simplified manufacturing, particularly secure screwing of the base body into the jaw bone is assured, even in the case of difficult conditions for the implantologist.

In accordance with the invention the task of further developing an enossal single tooth implant of this type is solved by way of the combination of features of claim 1. Special forms of embodiment of the invention are the subject matter of the sub-claims.

The single tooth implant according to the invention thus comprises a base body, an abutment which can be inserted into a base body and the retaining screw penetrating through the base body and abutment which determines the position of the abutment with regard to the base body and is screwed into a threaded section provided at the apical end of the base body.

The base body has an annular recess into which the abutment can be inserted. The annular recess comprises a guide section at the apical end of the annular recess, a form-fitting section which can be cylindrical or conical, and a coronal section to which the corresponding sections of the abutment are matched to be complementary in size.

In order to allow secure screwing of the base body into the jaw bone of the patient wherein even in the case of a not precisely matched diameter or angle of the boring in the jaw bone, an adequate torque can be applied to the base body, in one of the three sections of the base body, in addition to the form-fitting elements in the form-fitting section form-fitting screw-in elements, hereinafter referred to as screw-in elements in short, are provided, which after insertion of the screw-in tool, such as a screw-in bit with matched tool head, produce the form-fit between the screw-in element on the base body and the screw-in element on the screw-in tool, for example in the form of a male-female component connection, and thus allow the base body to be screwed into the jaw bone.

After screwing the base body into the jaw bone and removing the screw-in tool, the abutment can be inserted and aligned in the base body, wherein the form-fitting elements on the base body and abutment, at least one pair in the form of a male-female connection, can be brought into engagement with each other and thereby attach the base body and abutment to each other. The base body and abutment are then fixed in the relative position with regard to each other by the retaining screw.

In this way, due to its design according to the invention, the base body can be screwed with screw-in elements into the jaw bone by means of a tool engaging in the screw-in elements with a torque that is increased in relation to the embodiments of the prior art. Although the screw-in elements can be provided in each of the three sections (centring/guiding section on the apical end of the annular recess, the form-fitting section and the coronal end section), the screw-in elements are preferably arranged in the form-fitting section, which can be cylindrical or conical, between the apical guide section and the coronal end section A conical form-fitting section increases the diameter of the guide section to the diameter of the end section and is formed on the base body in the manner of a hollow truncated cone, to which a truncated cone on the abutment corresponds. In principle the form-fitting section on the base body can be in the form of a hollow cylinder, wherein then the at least one form-fitting element and the at least one screw-in element can lie on different planes.

In the area of the form-fitting section the screw-in elements are arranged on the base body in the circumferential direction, preferably between form-fitting elements on the base body which can be brought into engagement with the form-fitting elements on the abutment, and preferably in an alternating manner. The screw-in elements are then preferably designed so that with the screw-in tool applied there is only a form-fit between the screw-in elements on the base body and screw-in tool, so that the form-fitting elements on the base body cannot be damaged by the screw-in tool.

Accordingly, in this form of embodiment the form-fitting elements on the abutment and the screw-in elements on the base body are designed so that with the abutment inserted there is no contact between the form-fitting elements on the abutment and the screw-in elements on the base body and therefore no damage to the form-fitting elements on the abutment is possible.

With regard to the screw-in elements, arrangement of the male component(s) on the base body and the female component(s) on the screw-in tool or vice-versa is possible, wherein the embodiment with the male component(s) arranged on the screw-in tool and the female component(s) on the base body is preferred. The screw-in elements can each be designed in the form of a recess on the base body and, on the screw-in tool, a nose or projection engaging in the recess. The provision of at least one, more particularly two to six recess(es) in the form-fitting section on the base body is preferred. The recesses can also be designed as polygonal surfaces on the base body and screw-in tool in the manner of an inner-outer pair as a triangle, square or hexagon as in an Allen key. Here the provision of an inner triangle on the base body and a complementary outer triangle on the screw-in tool is of particularly advantage as on the base body circumferentially between the inner triangle surfaces three form-fitting elements can be alternately arranged, more particularly as tongue bars, designed for form-fitting with the grooves on the abutment.

Thus, in the form-fitting section recesses and base body-abutment form-fitting elements, the latter as anti-rotation protection, can be arranged so that circumferentially in the form-fitting section screw-in elements and basic body-abutment form-fitting elements can be provided, preferably in a form fitting manner.

For example, on the base body, two to six, more particularly three or four recesses or inner polygonal surfaces are provided as screw-in elements, with one base body form-fitting element between each two screw-in elements. Provided on the abutment to correspond with the base body form-fitting elements are form-fitting elements preferably in a quantity allowing alignment of the abutment. In the case of two, three or four base body form-fitting elements on the base body, correspondingly on the abutment for example just as many form-fitting elements or a whole number multiple thereof, such as two, three, four, six, eight, nine or more form-fitting elements can be provided.

A preferred form of embodiment of the invention is thus a single tooth implant for a fixed dental prosthesis, with, as defined above, a base body, abutment and retaining screw, wherein the base body and abutment each have a guide section, form-fitting section and end section complementary to each other, wherein the form-fitting section has two to six inner polygonal surfaces on the base body for the engagement of a screw-in tool, and, preferably alternately thereto, one, two to six tongue bars complementing each other as form-fitting elements on the base body and just as many grooves or a whole-number multiple thereof as form-fitting elements on the abutment. In the form-fitting section the screw-in elements and the tongue bars can be provided alternately on one plane or in two or more planes in the form-fitting section.

In accordance with the invention the form-fitting section of the base body and the form-fitting section of the abutment are matched to each other in shape so that the abutment can be inserted into the base body in such a way that the relevant form-fitting elements can be brought into engagement with each other and thus prevent a movement in the circumferential direction. Each of the form-fitting sections can be designed as hollow truncated cone-like or hollow cylindrical sections of the annular recess or boring, including with sections of different diameters, in the base body, and corresponding outer cylindrical section, or sections, of the abutment. The following description of the element of the invention applies for all forms of embodiment unless otherwise stated.

The guide section in the base body adjoins the threaded section for the retaining screw in the apical end of the base body. Arranged in the coronal direction thereto is the form-fitting section, in which at least one, more particularly two to six, more particularly three or four screw-in elements and at least two, three or four base body-abutment form-fitting elements are provided. Arranged further in the coronal direction is the end section in which a sealing element can be provided between the base body and the abutment. The sealing element can be designed in the form of an elastic seal which is arranged in a groove of the base body and abutment.

The axial lengths of the guide section, form-fitting section and end section are dimensioned so that guiding and form-fitting are ensured and the base body and abutment are sealed with regard to each other, by a cone or seal for example. The guide section and end section can both be longer than the form-fitting section. The sum of the axial lengths of the guide section and the form-fitting section is preferably greater than the length of the end section. The axial length of the guide section can be smaller than, equal to or greater than the axial length of the end section. If the guide section is longer than the end section the guide section has the primary guide function.

In accordance with the invention the, preferably cylindrical sections (guide section and end section), provided axially on both sides of the form-fitting section, allow reliable and stable fixation of the abutment in the base body through the retaining screw, as the abutment and base body are assembled in the form of a pipe-in-pipe mounting via the guide section and end section. The radial inner diameters of the guide section and end section in the base body, and accordingly also of the outer diameter in the abutment are selected so that the wall thickness in the base body is sufficient to prevent deformation of the base body walls in the event of lateral or angular stressing of the implant through the chewing process when the implant is inserted in the jaw bone. The wall thickness of the base body in the area of the annular recess can be 30% to 50% of the inner diameter in the guide section and 10 to 20% of the inner diameter in the end section.

In one form of embodiment according to the invention the form-fitting section of the base body can be designed as a hollow truncated cone. In this case the form-fitting section of the abutment is configured as a truncated cone corresponding to the hollow truncated cone.

In this form of embodiment the form-fitting section of the base body is in the form of a hollow truncated cone with a circular surface with a smaller diameter (cover surface) and with a circular surface of a larger diameter (base surface), wherein the longitudinal axis of the hollow truncated cone is arranged coaxially to the longitudinal axis of the base body, the circular surfaces define the hollow truncated cone and circular surface with the larger diameter faces the coronal end of the base body.

Due to the design according to the invention of the base body with the screw-in elements, the base body can be screwed into the jaw bone by means of a tool engaging in the screw elements with increased torque compared with the prior art and after insertion into the base body the abutment is reliably secured against rotation.

In accordance with the invention the complementary form-fitting elements on the basic body and abutment are each configured in the form of a male-female connection, wherein the male component(s) is/are preferably arranged on the base body. As result of the thus selected arrangement, due to the avoidance of a reduction in the wall thickness of the base body, precise force transmission is possible even in the case of ceramic materials and the use of a fully or partially ceramic base body and/or abutment is made possible in addition the known metals and alloyed materials. However, it is also possible for the male component(s) to be arranged on the form-fitting section of the abutment and the corresponding female components on the base body.

According to the invention the male form-fitting element can have the form of a tongue bar extending in parallel to the longitudinal axis of the base body and engaging in a corresponding female element on the other component secured against rotation. The form-fitting elements can be produced through mechanical machining, such as milling, drilling etc. from the components base body and abutment.

The form-fitting section can be designed cylindrically or preferably conically. In a cylindrical embodiment the form-fitting section on the abutment is configured in the form of a cylindrical section which with its outer diameter is matched in length and diameter to the hollow cylindrical boring on the base body.

In the embodiment of the form-fitting sections as a hollow truncated cone on the base body and truncated cone on the abutment, the at least one tongue bar can be designed so that depending on the arrangement on the base body or abutment, the tongue bar is radially raised around the longitudinal axis of the base body or abutment and extends axially thereto in a wedge-like manner in the direction of the larger diameter of the truncated cone or hollow truncated cone and does not increase the diameter of the larger circular surface closing the truncated cone. The radial height of the tongue bar thus maximally corresponds to the difference in the radii of the circular surfaces closing the truncated cone or hollow truncated cone less a clearance.

According to the invention such a tongue bar can be in the form of a pin held in a blind hole (retaining boring), wherein the blind hole is provided coaxially to the longitudinal middle axis of the base body in the conical area of the hollow truncated cone or truncated cone, depending on relative length of the male and female component, in the base body or in the abutment up to the area parallel to the threaded section. Due to the conical surface on the hollow cone/truncated cone, each pin is guided at least partially in a groove with a cross-section decreasing towards the end opposite the retaining boring, which results in a type of wedge shape of the tongue bar. In order to make the wall thickness in the form-fitting section as thick as possible, depending on the relative length of the male and female component in the base body or in the abutment, the blind hole for receiving the pin or groove is arranged in such a way that the circumferential line of the boring tangentially contacts the circumferential line of the circular surface at the apical end or the boring is partially arranged in the circular surface at the apical end.

The pins can each have a preferably circular, or regular or irregular polygonal cross-section, from which a cross-section segment projects from the groove in the conical wall radially to the direction of the longitudinal middle axis of the base body or abutment, depending on the relative length of the male and female component, and can form the tongue bar beyond the maximum axial length of the form-fitting section. In the simplest form a pin can have a cylindrical shape and be produced in a wire-drawing machine. It is possible to produce the pin of a material with a greater strength than the material of the abutment or base body.

To secure the pin axially, each pin can be fitted/inserted into the blind hole by press fitting.

In accordance with the invention, of particular advantage is the embodiment in which the screw-in elements and form-fitting elements can be produced from the base body by mechanical machining, such as milling, and the internal polygonal surfaces and tongue bars produced in this way.

In order to allow the insertion of the abutment in circumferentially different positions, the form-fitting elements can have an angular degree division in relation to the circumference of the abutment and base body allowing the insertion of the abutment into the base body in various positions, such as a 15, 30, 45, 60, 90, 120 or 180 degree division. Additionally, the number of female form-fitting elements can be equal to or greater than, for example double or triple, depending on the sub-division, that of the male form-fitting elements. Preferred is the combination of one form-fitting element such as a pin on the base body with one to six form-fitting elements such a groves on the abutment, or correspondingly, two form-fitting elements on the base body and two, four or six form-fitting elements on the abutment, three form-fitting elements on the base body and three or six form-fitting elements on the abutment, or four form-fitting elements on the base body and four or eight form-fitting elements on the abutment, wherein the form-fitting elements are each regularly spaced around the circumference.

In one embodiment according to the invention in the form-fitting section the abutment can have a support collar for the pins of the base body. On inserting the abutment into the base body the pins can with their coronal ends at least partially rest on the support collar the width of which can maximally correspond to the diameter, but in particular approximately the radius of a pin, and on turning the abutment for radially aligning the abutment as specified by the implantologist can engage in the form-fitting grooves

As stated above, on the abutment side sealing means such as an O-ring can be provided in a circumferential groove in the end section in order, after insertion of the implant in the patient to prevent the penetration of foreign bodies and fluid into the hollow spaces of the implant. If required, additionally or alternative sealing means such as an O-ring can also be arranged in a groove on the base body side wherein the latter is less preferred.

For the implant post/retaining screw an inner thread can be provided in the blind hole apically of the form-fitting and centring section of the base body, wherein the retaining screw can also completely traverse the abutment.

The invention also relates to a base body and abutment as individual components of an implant according to the invention, which are overall designed according to the embodiment details for the implant.

It is an essential aspect of the present invention that as functional the elements, the elements for screwing in the implant and the form-fitting elements for fixing the position of the base body and abutment relative to each other are separate from each other and the form-fitting elements are not also configured for screwing the base body into the jaw bone. In addition the present invention makes it possible that in addition to simplified mechanical machining of the components base body and abutment, which are each produced with corresponding form-fitting elements in the form of the above-described groove-tongue connection in a centring and guiding section, a balanced mechanical stability can be achieved when inserting the implant into the jaw bone and during its use during the chewing process, which is not the case in systems known from the prior art. At the same time, compared with the solutions known in the prior art, the processing of base body and abutment blanks is considerably simplified and more cost-effective.

Examples of embodiment of the single tooth implant according to the invention and its components are explained in detail below with the aid of the schematic drawings. In these:

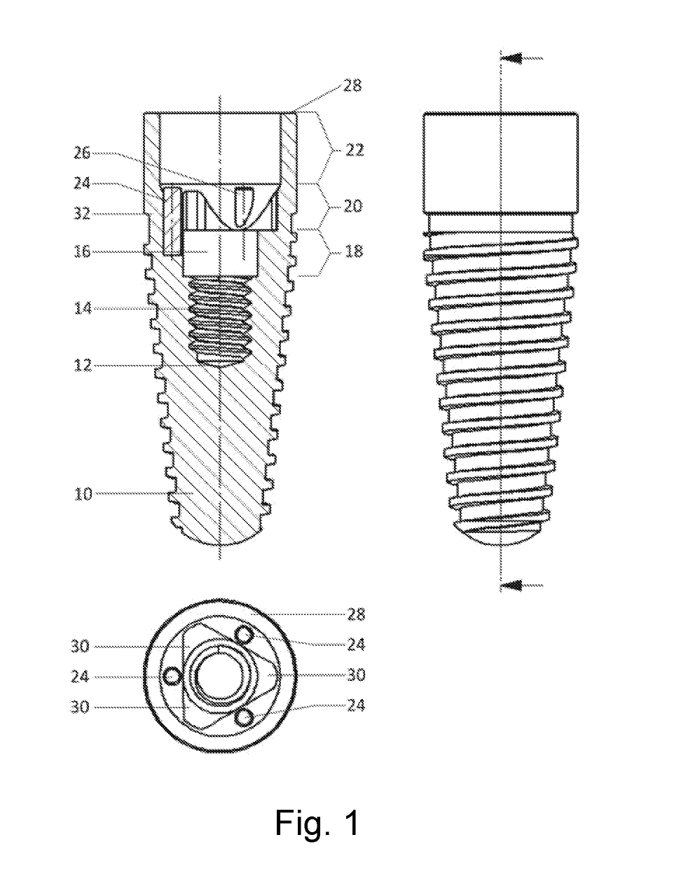

FIGS. 1 to 5 show a first form of embodiment of the single tooth implant according to the invention with a basic body and abutment;

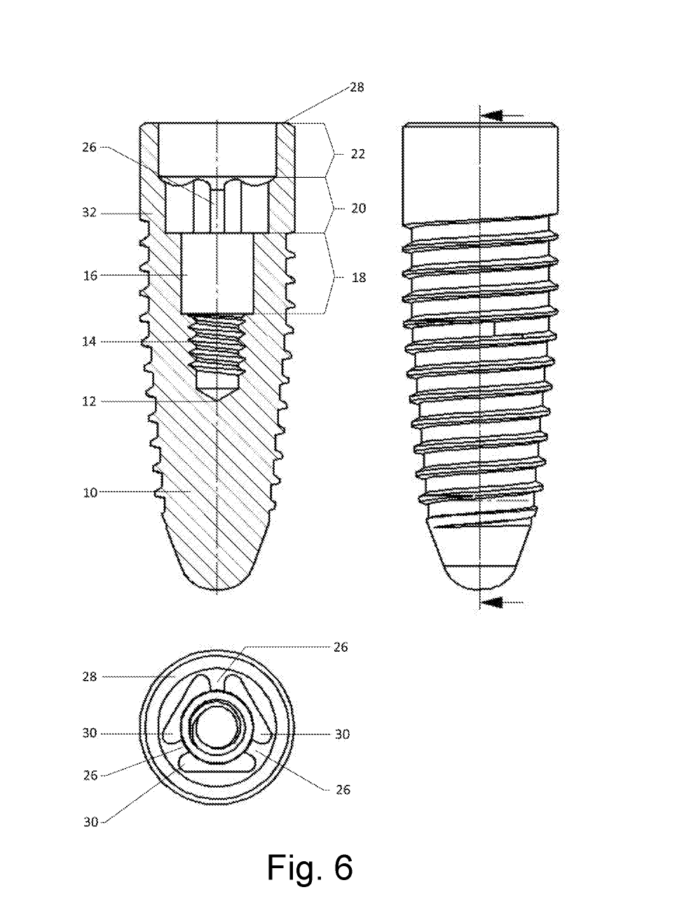

FIGS. 6 to 10 show a second particularly preferred form of embodiment of the single tooth implant according to the invention with a base body with an inner polygon and abutment; and

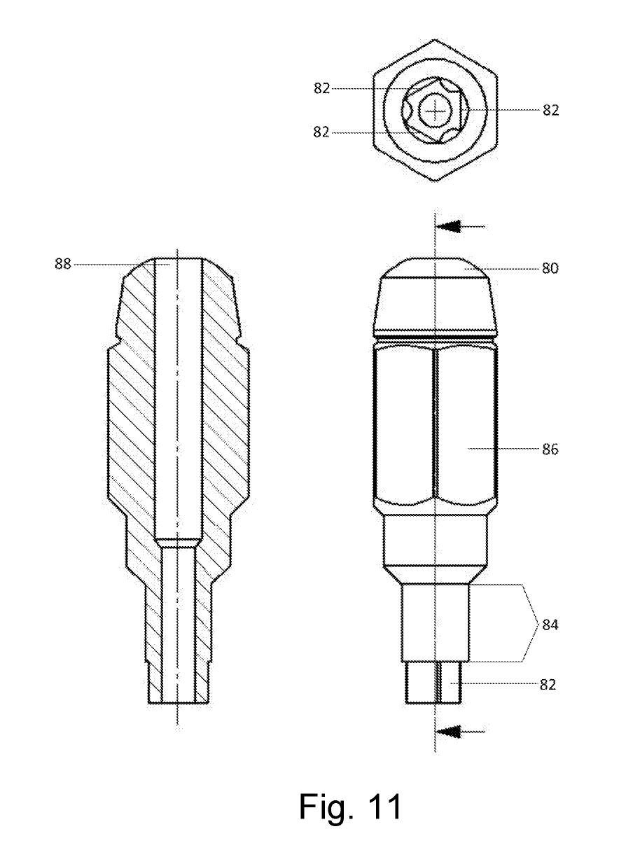

FIG. 11 shows an example of embodiment of a screw-in tool for screwing a base body of a single tooth implant according to the invention into the jaw bone.

In more detail:

FIG. 1 in the upper left section shows an example of embodiment of a preferred base body of the enossal single tooth implant according to the invention in an axial longitudinal section along the plane shown on the right in the view from above and in the lower section a view of the base body from above;

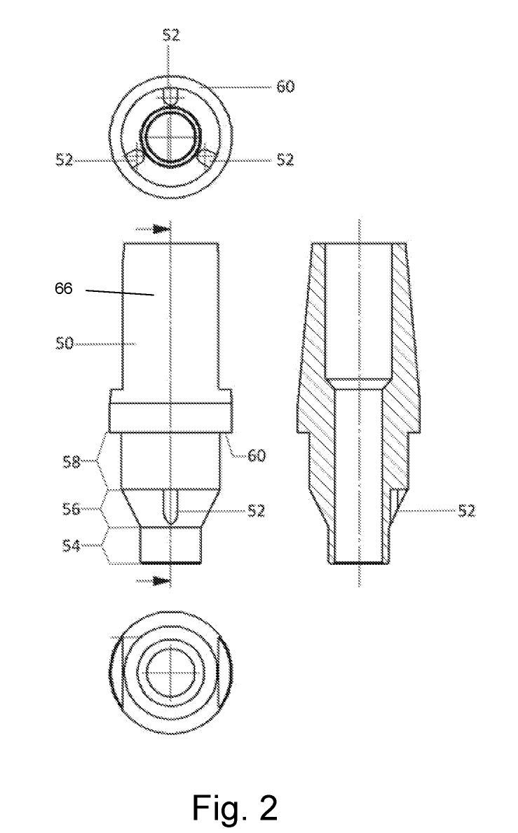

FIG. 2 shows a view corresponding to FIG. 1 from above of an example of embodiment of an abutment of the single tooth implant matched to the basic body of FIG. 1, a longitudinal section in a plane at right angles to the previous view, as well as views of the abutment from above (bottom) and below (top);

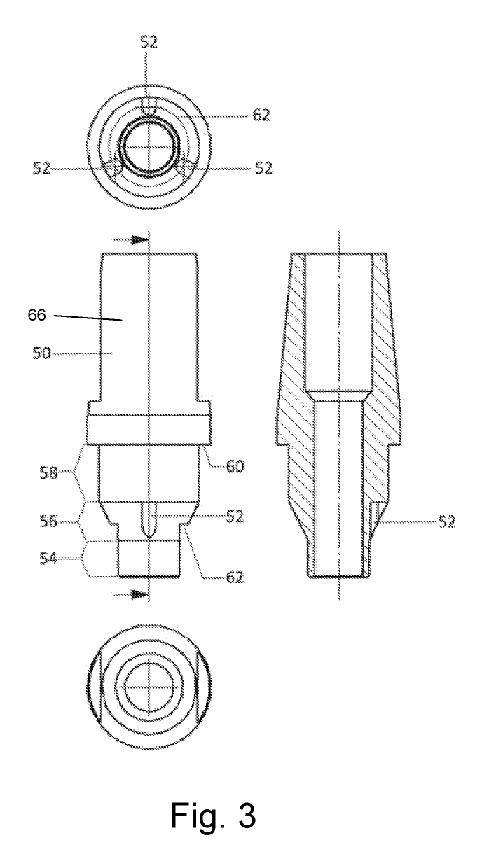

FIG. 3 shows a modification of the example of embodiment shown in FIG. 2 of an abutment of the single tooth implant in a view corresponding to FIG. 1, a longitudinal section in a plane at right angles to the previous view, as well as views of the abutment coronally from above (bottom) and apically from below (top);

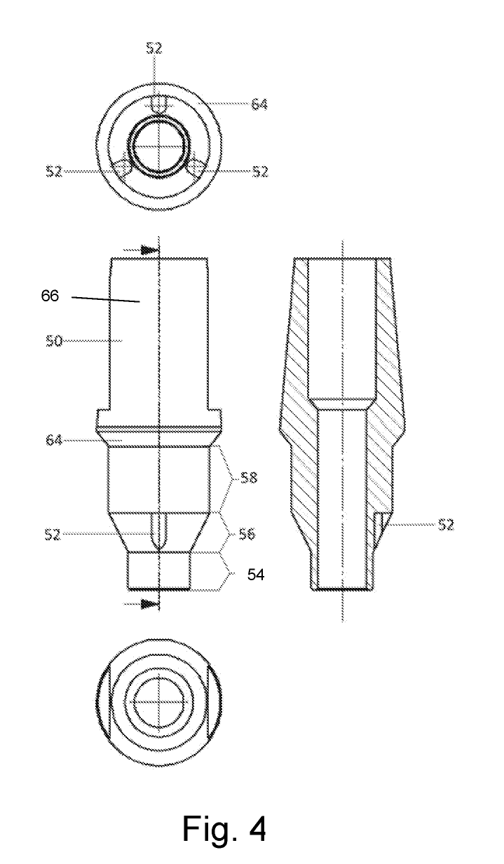

FIG. 4 shows a further modification of the example of embodiment shown in FIG. 2 of an abutment of the single tooth implant in a view corresponding to FIG. 1, a longitudinal section in a plane at right angles to the previous view as well as top views of the abutment from above (bottom) and from below (top);

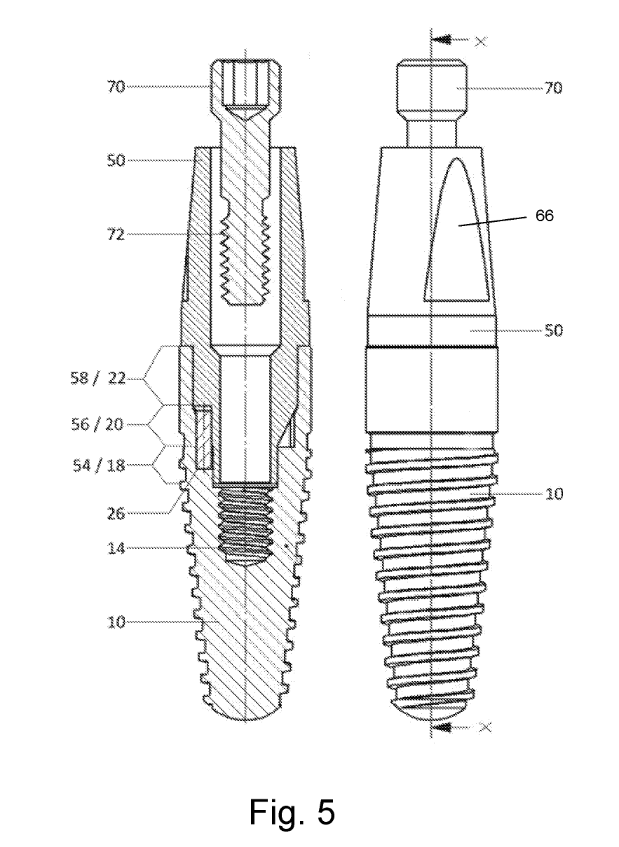

FIG. 5 shows an example of embodiment of an enossal single tooth implant according to the invention in an axial longitudinal section along the plane shown in the top view on the right; and

FIG. 6 in the top left section shows an example of embodiment of a preferred base body of the enossal single tooth implant according to the invention in a axial longitudinal section along the plane shown on the right in the view from above, and in the lower section a top view of the base body from above;

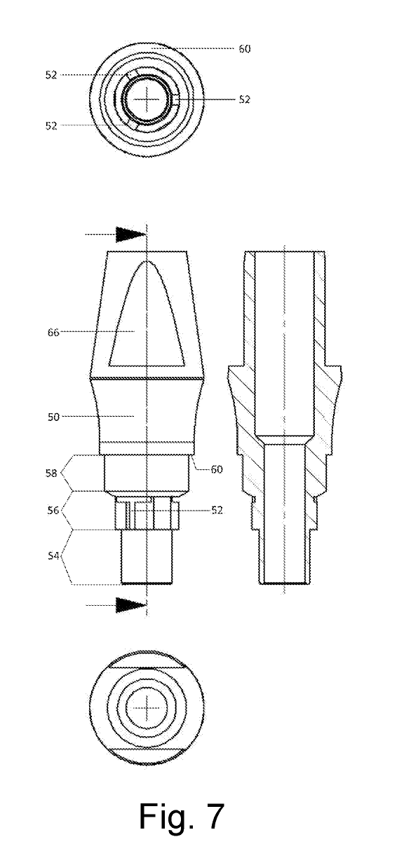

FIG. 7 shows a view corresponding to FIG. 6 from above of an example of embodiment of an abutment of the single tooth implant matched to the basic body of FIG. 6, a longitudinal section in a plane at right angles to the previous view, as well as views of the abutment from above (bottom) and below (top);

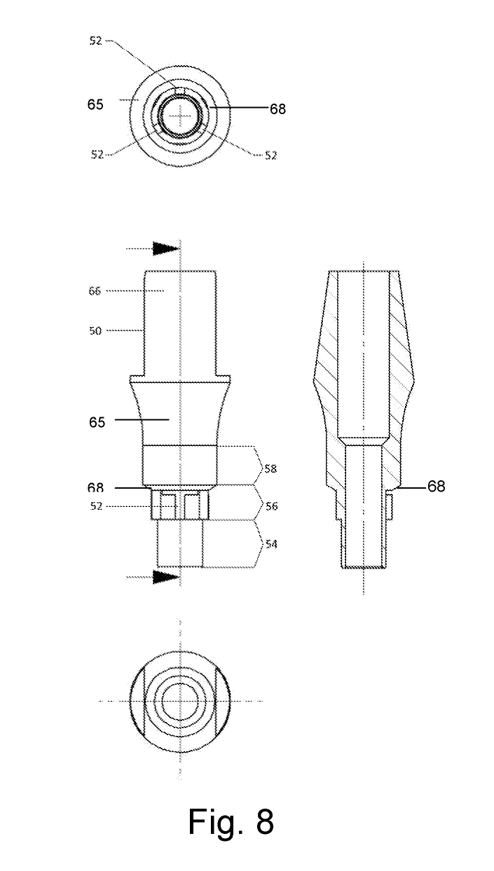

FIG. 8 shows a modification of the example of embodiment shown in FIG. 7 of an abutment of the single tooth implant in a view corresponding to FIG. 6, a longitudinal section in a plane at right angles to the previous view as well as top views of the abutment from above (bottom) and from below (top);

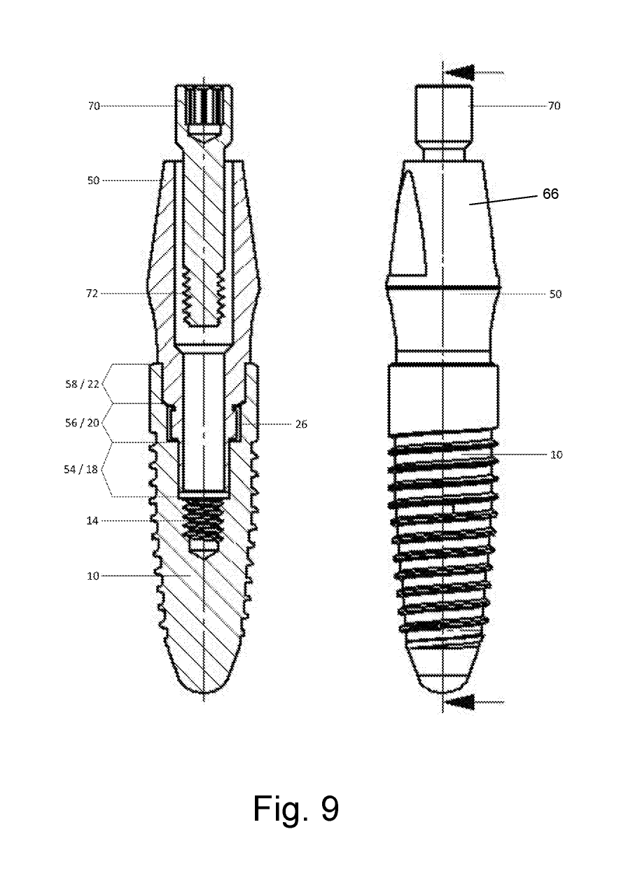

FIG. 9 shows a preferred example of embodiment of an enossal single tooth implant according to invention in an axial longitudinal section along the plane shown in the top view on the right; and

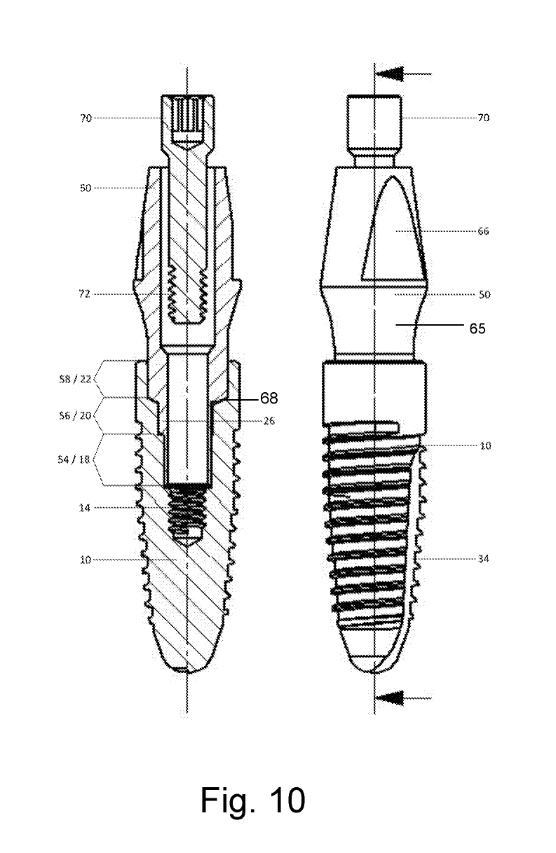

FIG. 10 shows a further preferred example of embodiment of an enossal single tooth implant according to the invention in a longitudinal section along the plane shown on the right in the view from above; and

FIG. 11 shows an example of embodiment of a screw-in tool in a longitudinal section along the plane shown on the right in the view from above, and in the upper section a top view of the screw-in tool from below.

As shown in FIG. 1, the single tooth implant in the example of embodiment shown there comprises a base body 10, which is closed at its apical end shown in FIG. 1, bottom, and has a blind hole 12, open towards its coronal end in FIG. 1, top, with an internal thread 14 close to the apical end of the blind hole 12. A retaining screw 70, not shown in the drawing, can be screwed into the internal thread. Adjoining the internal thread 14 of the base body 10 in the coronal direction is a hollow cylindrical annular recess 16 with an internal diameter larger than the internal thread 14. In the shown form the annular recess 16 has three sections (18; 20; 22).

The annular recess 16 has a guide section 18 coronally adjoining the internal thread 14. Adjoining the guide section 18 of the annular recess 16 in the coronal direction is a form-fitting section 20 which has an internal diameter increasing in the coronal direction with regard to the guide section 18 and a conical inner wall with—in the form of embodiment according to FIG. 1—three tongue bars 26 directed radially inwards. The tongue bars 26 are configured to correspond to the form-fitting grooves 52 on the abutment 50 in the manner of a groove-tongue connection, and can be dimensioned so that they extend over the entire axial length of the form-fitting section 20. The tongue bars 26 can be formed out of the base body by mechanical processing. However, advantageously it is also possible to form the tongue bars 26 in that in the form-fitting section 20 pins 24 are held in axial retaining groove borings evenly distributed around the circumference. A retaining groove boring thus comprises a blind hole in the wall 32 of the guide section 18 and a retaining groove in the form-fitting section 20. Each of the pins 24 can be inserted with a cross-section matched to the retaining groove boring, for example as a cylinder pin, into the blind hole of the retaining groove boring in the wall 32 of the guide section 19 and held in the form-fitting section 20 radially partially surrounded by retaining groove so that an inwardly directed tongue bar 26 which corresponds to the form-fitting groove 52 of the abutment 50 is formed. The thickness of a pin preferably corresponds to between the difference, or half thereof, of the radii of the end section 22 and the guide section 18, less a clearance. Thus, even on insertion of the abutment 50 into the base body 10 guiding over the guide section 18 between the pins 24, preferably three or four evenly distributed around the circumference, is possible.

In the coronal direction an end section 22 adjoins the form-fitting section 20 with a coronal front edge 28. The end section 22 has an inner wall corresponding to the outer diameter of the sealing section 58 of the abutment 50. In the end section 22, on the area facing the form-fitting section 20 a band can be provided on which a collar provided on the abutment can come into contact. As a height stop for the abutment, the front edge 28 can also be envisaged for the sealing collar 60 of the abutment.

In FIG. 1, in the form-fitting section 20 three recesses 30 are provided as screw-in elements in which the corresponding screw-in elements 82 of the screw-in tool 80 shown in FIG. 6 can engage when screwing the base body 10 into the jaw bone.

The base body 10 can be simply produced through mechanical machining of a blank. Advantageous for this is the design of the tongue bars as cylinder pins 24 each arranged in a retaining groove boring in the form-fitting section 20 of the base body 10. Before producing the form-fitting section, borings can be bored coaxially to the blind hole 12 up to the wall 32 in the guide section 18 of the base body 10 and during milling of the form-fitting section 20 with a bevel cutter formed as retaining groove borings in the form-fitting section 20 and the wall 32.

Even though the use of cylinder pins is advantageous in production terms, it is also possible to use pins with a regular or irregular polygonal cross-section and a retaining groove boring with a matching cross-section and matching form-fitting groove 52.

Via the securing head 66, an abutment 50 shown in FIG. 2 is for fastening a fixed dental prosthesis, which is not shown. In the usage position, under the sealing collar 60 which can be mounted on the front edge 28 of the base body 10, in the apical position the abutment 50 has an end section 58 which can have a circumferential groove, not shown, for receiving sealing means such as an O-ring, not shown, in the end section 58, a form-fitting section 56 and a guide section 54. In the form-fitting section 56 a number of axially extending form-fitting grooves 52 are provided, which in terms of their shape and arrangement, but not necessarily number, correspond to the tongue bars 26 in the form-fitting section 20 of the base body.

On insertion of the abutment 50, which is provided with an axial longitudinal boring, the inner diameter of which corresponds to approximately the outer diameter of the retaining screw [(70) in FIG. 5], which is not shown in FIG. 2, into the base body 10, the guide section 54 engages in the guide section 18 of the annular recess 16 wherein the smooth cylinder jacket surface of the guide section 54 comes into contact on the inner cylinder jacket surface of the guide section 18 of the base body 28.

The end section 58 of the abutment 50 can be arranged to fit snugly in the end section 22 of the base body 10. The tongue bars 26 engage in the form-fitting grooves 52, while the sealing collar 60 comes into contact on the front edge 28. In this way the abutment 50 is fastened to the base body 10 in a tight and form-fitting manner, protected against rotation.

By means of the retaining screw 70 which traverses the abutment 50 and can be screwed into the internal thread 14 of the base body 10, the abutment 50 can be securely connected to the base body 10. To facilitate the removal of the abutment 50 from the base body 10, in the boring traversing the abutment an internal thread, which is not shown in FIG. 2, can be provided, into which, after removal of the retaining screw an impression post, not shown, with an external thread can be screwed, which is supported with its apical end on the internal thread 14 of the base body. When screwing in the impression post the abutment 50 is coronally raised out of the base body 10 and can be removed.

Depending on the division or division ratio of the base body 10 and abutment 50, the abutment 50 can be inserted into the base body 10 in different rotational positions, for example in a degree division of 30°, 45°, 60°, 90°, 120° or 180°, through which the treating doctor has a number of configuration options available. The number of abutment form-fitting elements 52 can preferably be greater than the number of base body form-fitting elements 26. Thus, advantageous in accordance with the invention are embodiments of two tongue bars 26 as pins in the base body 10 and two, four, six, eight, ten or twelve form-fitting grooves 52 on the abutment 50or, in particular of three tongue bars 26 as pins 24 in the base body 19 and three, six, nine or twelve form-fitting grooves 52 on the abutment 50.

In the form-fitting section 56, the form of embodiment shown in FIG. 3, additionally with regard to the form of abutment 50 shown in FIG. 2, has a support collar 62 for the tongue bars 26 of the base body 10 shown as pins 24 in accordance with the example of embodiment in the drawing. On inserting the abutment 50 into the base body 10 the tongue bars 26, here as pins 24, can with their coronal ends at least partially rest on the support collar 62, the width of which can approximately correspond to the radius of a pin 24, and on turning engage in the form-fitting grooves 52 for radially aligning the abutment as specified by the implantologist. In this form of embodiment the form-fitting grooves 52 on the abutment 50 can thus be shorter than the tongue bars on the base body 10.

Instead of the collar (60) shown in FIG. 2, the form of embodiment of the abutment shown in FIG. 4 has a conical band 64 on the abutment 50. In this form of embodiment the abutment 50, with a complementary conical configuration of the front edge 28 of the end section 22 of the base body 10 can be arranged in this conical area for sealing contact between the base body 10 and abutment 50. Both in this form of embodiment of FIG. 4 and in the embodiment of the abutment according to FIG. 2 and FIG. 3, it is preferable that the sealing sections come into contact before the conical surfaces in the form-fitting section (22, 56) of the base body and abutment come into contact and less clearance is thus present in the form-fitting section so that the form-fitting elements engage in each other, but the conical surfaces are not yet in contact.

FIG. 5 in the top view on the right shows an abutment 50 inserted into a base body 10 with a retaining screw 70 inserted into the boring of the abutment, but not yet screwed into the base body, and on the left the example of embodiment of the enossal single tooth implant according to the invention in an axial longitudinal section along the plane shown in the top view on the right with base body 10, abutment 50 and retaining screw 72 which can be screwed into the thread 14 of the base body 10. In the area of the sealing collar 60 of the base body or the conical band 64, on the abutment and/or the base body, at least one marking/indexing can be provided on the outer side which makes it easier for the implantologist to align the components and indicates the position of the form-fitting elements.

As shown in FIG. 6, the single tooth implant in the example of embodiment shown there comprises a base body 10 which is closed at its apical end shown in FIG. 1, bottom, and has a blind hole 12, open towards its coronal end in FIG. 1, top, with an internal thread 14 close to the apical end of the blind hole 12. A retaining screw 70, not shown in the drawing in FIG. 1, can be screwed into the internal thread. Adjoining the internal thread 14 of the base body 10 in the coronal direction is a hollow cylindrical annular recess 16 with an internal diameter larger than the internal thread 14. The annular recess 16 in the shown form has three sections (18; 20; 22).

The annular recess 16 has a guide section 18 coronally adjoining the internal thread 14. Adjoining the guide section 18 of the annular recess 16 in the coronal direction is a form-fitting section 20 which has a coronally increased inner diameter compared to the guide section 18 and has a conical inner wall with—in the form of embodiment according to FIG. 1—three tongue bars 26 directed radially inwards 26. The tongue bars 26 are configured to correspond to the form-fitting grooves 52 on the abutment 50 in the manner of a groove-tongue connection, and can be dimensioned so that they extend over the entire axial length of the form-fitting section 20. The tongue bars 26 can be formed out of the base body by mechanical or electrochemical processing.

In FIG. 6, in the form-fitting section 20 three internal edge surfaces 30 are provided as screw-in elements in which the corresponding external edge surfaces 82 can engage as screw-in elements on the screw-in tool 80 shown in FIG. 6 when screwing the base body 10 into the jaw bone. For mechanical and geometric reasons the use of three internal edge surfaces on the base body 10 is advantageous, but four or six internal edge surfaces can also be provided, on which the external edge surfaces engage as screw-in elements 82 of the screw-in tool 80 as long as the form-fitting elements on the base body 10 and abutment can be reliably brought into engagement when inserting the abutment 50.

In a similar manner to FIG. 2, the abutment shown in FIG. 7 serves to fasten, via the securing head 66, a fixed dental prosthesis, which is not shown. In the usage position, under the sealing collar 60 which can be mounted on the front edge of the base body 10, in the apical position the abutment 50 has an end section 58 which can have a circumferential groove, not shown, for receiving sealing means such as an O-ring, not shown, in the end section 58, a form-fitting section 56 and a guide section 54. In the form-fitting section 56 a number of axially extending form-fitting grooves 52 are provided, which in terms of their shape and arrangement, but not necessarily number, correspond to the tongue bars 26 in the form-fitting section 20 of the base body 10. In the inserted state that form-fitting grooves 52 are in engagement with the tongue bars 26, whereas the screw-in elements 30 on the base body 10 are not in contact with the abutment 50.

On insertion of the abutment 50, which is provided with an axial longitudinal boring, the inner diameter of which corresponds to approximately the outer diameter of the retaining screw [(70) in FIG. 5 or FIG. 9], which is not shown in FIG. 2, into the base body 10 the guide section 54 engages in the guide section 18 of the annular recess 16 wherein the smooth cylinder jacket surface of the guide section 54 comes into contact on the inner cylinder jacket surface of the guide section 18 of the base body 10.

The end section 58 of the abutment 50 can fit snugly in the end section 22 of the base body 10. The tongue bars 26 engage in the form-fitting grooves 52, while the sealing collar 60 comes into contact on the front edge 28. In this way the abutment 50 is fastened to the base body 10 in a tight and form-fitting manner, protected against rotation.

By means of the retaining screw 70 which traverses the abutment 50 and can be screwed into the internal thread 14 of the base body 10, the abutment 50 can be securely connected to the base body 10. To facilitate the removal of the abutment 50 from the base body 10, in the boring traversing the abutment an internal thread, which is not shown in FIG. 2, can be provided, into which, after removal of the retaining screw an impression post, not shown, with an external thread can be screwed, which is supported with its apical end on the internal thread 14 of the base body. When screwing in the impression post the abutment 50 is coronally raised out of the base body 10 and can be removed.

The form of embodiment of the abutment 50 with securing head 56 shown in FIG. 8 instead of the collar 60 shown in FIG. 7, has a conical band 68 on the transition between form-fitting section 56 and end section 58 on the abutment 50. In this form of embodiment, the abutment 50 is not, as in the form of embodiment in FIG. 7. held via a collar 60 on the front edge 28 of the base body 10, but is supported by way of the conical band 68 on a corresponding conical section of the base body 10 as shown in FIG. 10. In this embodiment, in the end section 58 a circumferential groove, not shown, for receiving sealing means, such an a, not shown, O-ring, can preferably be provided. In the area of the face edge 28 of the base body 10 or the sealing collar 60 of the abutment 50, as shown in the figure of the individual components, on the outside of each at least one marking/indexing can be provided which makes it easier for the implantologist to align the components and indicates the position of the form-fitting elements.

FIG. 9 in the top view on the right shows an abutment 50 with a securing head 56 and sealing collar 60 as shown in FIG. 7 inserted into a base body 10 with a retaining screw 70 inserted into the boring of the abutment, but not yet screwed into the base body, and on the left the example of embodiment of the enossal single tooth implant according to the invention in an axial longitudinal section along the plane shown in the top view on the right with base body 10, abutment 50 and retaining screw 72 which can be screwed into the thread 14 of the base body 10. In the area of the face edge 28 of the base body 10 or the sealing collar 60 of the abutment 50, as shown in the figures of the individual components, on the outside of each at least one marking/indexing can be provided which makes it easier for the implantologist to align the components and indicates the position of the form-fitting elements.

Similarly to FIG. 9, in the top view on the right FIG. 10 shows an abutment 50 without a sealing collar 60 as shown in FIG. 8 inserted into a base body 10 with a retaining screw 70 inserted into the boring of the abutment, but not yet screwed into the base body, and on the left the example of embodiment of the enossal single tooth implant according to the invention in an axial longitudinal section along the plane shown in the top view on the right with base body 10, abutment 50 and retaining screw 72 which can be screwed into the thread 14 of the base body 10. In the area of the face edge 28 of the base body 10 or the conical section 65 of the abutment 50, on the outside of each at least one marking/indexing can be provided which makes it easier for the implantologist to align the components and indicates the position of the form-fitting elements. In this form of embodiment the abutment 50 is supported via the conical band 68 on a corresponding section of the base body 10. As in all main bodies according to the invention, on the outside of the base body a flute 34 can be provided which extends to beyond the apical tip of the base body and is intended for the receiving and removal of bone slivers and tissue pieces which can occur when screwing the abutment into the jaw bone.

In the top view on the right, FIG. 11 shows a screw-in tool 80 insertable into a base body with three screw-in elements such as outer polygonal surfaces or nose/cams 82, tool guide section 84 which on screwing the base body 10 into the jaw bone is guided in the end section 22 of the base body 19, and hexagon 86 to which a socket wrench or angle piece can be applied. On the screw-in tool, for example at the upper end of the tool guide section 84, on the outer side at least a marking/indexing can also be provided which makes it easier for the implantologist to align the screw-in tool 80 to the base body and indicates the position of the tongue bars 26 in the base body 10 as well as of the outer polygonal surfaces 82. To facilitate the removal of the tool 80 from the base body 10 in the event of unlikely tilting, in the boring 88 traversing the screw-in tool 80 an inner thread, not shown in FIG. 10, can be provided into which after removal of the retaining screw an impression post, not shown, with an external thread can be screwed, which is supported with its apical end on the internal thread 14 of the base body. On screwing in of the impression post the tool 80 is coronally raised out of the base body 10 and can be removed.

### LIST OF REFERENCE NUMBERS

10 Base body

12 Boring

14 Inner thread

16 Annular recess

18 Guide section

20 Form-fitting section

22 End section

24 Pin

26 Tongue bar

28 Front edge

30 Screw-in element/recess/inner edge surface

32 Wall

34 Flute

50 Abutment

52 Form-fitting grove

54 Guide section

56 Form-fitting section

58 End section

60 Sealing collar

62 Support collar

64 Conical band

65 Conical section

66 Securing head

68 Conical band

70 Retaining screw

72 Thread

80 Screw-in tool

82 Screw-in element/polygonal surface

84 Tool guide section

86 Hexagon

88 Inner boring

1. Enossal single tooth implant for a fixed dental prosthesis with
a. an essentially cylindrical base body (10), which can be inserted into a
boring in a jaw bone, with an annular recess (16) and with a boring (12), open towards its coronal end, which is arranged apically to the annular recess (16) and has a threaded section (14) arranged at an apical end in the base body for fastening a retaining screw, wherein the annular recess (16) comprises a guide section (18), a form-fitting section (20) and an end section (22),
b. an abutment (50) with a form-fitting section (56) which can be inserted in the recess (16) of the base body, with a boring for receiving the retaining screw and with a securing head (66) for the dental prosthesis, and
c. a retaining screw (70) which can be inserted into the boring of the base body (10) and traverses the abutment,
wherein the form-fitting section (20) of the base body (10) and the form-fitting section (56) of the abutment (50) are complementary to each other in shape,
wherein the form-fitting section (20) of the base body (10) has at least one base body form-fitting element (26) acting in the circumferential direction and the form-fitting section (56) of the abutment (50) has at least one abutment form-fitting element (52) which is complementary to the base body form-fitting element (26) shape,
wherein the abutment (50) can be inserted into the annular recess (16) of the base body (10) in such a way that the respective form-fitting elements (26; 52) are brought into engagement with each other,
wherein the form-fitting elements (26; 52) complementary to each other are configured in the form of a male-female component connection, and
wherein in addition to the complementary form-fitting elements (26; 52), at least one screw-in element (30) acting in a circumferential direction is provided for the engagement of a screw-in tool in one of the guide section (18), form-fitting section (20) and end section (22).

2. Single tooth implant according to claim 1 in which the at least one screw-in element (30) acting in the circumferential direction for the engagement of a screw-in tool, and the form-fitting elements (26; 52) complementary to each other are arranged in the form-fitting section (20).

3. Single tooth implant according to claim 1 or 2 in which two to six, more particularly three or four circumferentially acting screw-in elements (30) are formed in the form-fitting section (20).

4. Single tooth implant according to claim 3 in which the screw-in elements (30) acting in the circumferential direction and the form-fitting elements (26; 52) complementary to each other are arranged alternately in the form-fitting section (20).

5. Single tooth implant according to any one of the preceding claims in which
the at least one screw-in element (30) acting in the circumferential direction is in the form of a recess in the base body (10).

6. Single tooth implant according to any one of the preceding claims in which
two to six, more particularly three or four screw-in elements (30) acting in the circumferential direction are each designed in the form of an inner polygonal surface in the base body (10).

7. Single tooth implant according to claim 5 or 6 in which three or four
screw-in elements (30) acting in the circumferential direction each alternate circumferentially with three or four form-fitting elements in the base body (10).

8. Single tooth implant according to any one of the preceding claims in which
the form-fitting section (20) of the base body (10) is in the form of a hollow truncated cone, wherein the longitudinal axis of the hollow truncated cone is coaxial to the longitudinal axis of the base body and the abutment (50) has a truncated cone corresponding to the hollow truncated cone, or in which the form-fitting section (20) of the base body (10) is in the form of a hollow cylinder, wherein the longitudinal axis of the hollow cylinder is coaxial to the longitudinal axis of the base body, and the abutment (50) has an outer cylindrical section corresponding to the hollow cylinder.

9. Single tooth implant according to any one of the preceding claims in which the male component is arranged as a form-fitting element (26) on the base body (10) and the corresponding female component as a form-fitting element (52) on the abutment (50).

10. Single tooth implant according to any one of the preceding claims in which
the male-female connection is formed in that a tongue bar (26) extending in parallel to the longitudinal axis of the base body (10) is provided which engages in a corresponding groove (52) on the other component secured against rotation.

11. Single tooth implant according to claim 10 wherein the tongue bar (26)
is in the form of a bar mechanically or electrochemically ablated from the base body blank.

12. Single tooth implant according to claim 10 wherein the tongue bar (26) is
in the form of a pin (24) held in a boring or groove.

13. Single tooth implant according to any one of the preceding claims in which the
form-fitting elements complementary to each other in relation to the circumference of the base body and the abutment, have a coordinated angular degree spacing.

14. Single tooth implant according to any one of the preceding claims in which the
number of female form-fitting elements is larger than the number of male form-fitting elements.

15. Screw-in tool (80) for screwing the base body of the enossal single tooth implant according to any one of claims 1 to 14 into the jaw bone of a patient, with at least one screw-in element (82) with a tool guide section (84) for guiding the essentially cylindrical screw-in tool (80) over the end section (22) and with a tool connection section (86).
